(19) United States
(12) Patent Application Publication
(10) Pub. No.: US 2022/0183224 A1
(43) Pub. Date: Jun. 16, 2022

(54) Remote Control for a Mower

(71) Applicant: Christopher M. Wilt, Clarksburg, WV (US)

(72) Inventor: Christopher M. Wilt, Clarksburg, WV (US)

(21) Appl. No.: 17/550,563

(22) Filed: Dec. 14, 2021

Related U.S. Application Data
(60) Provisional application No. 63/125,110, filed on Dec. 14, 2020.

(51) Int. Cl. A01D 34/00; A01D 69/03; A01D 69/02

(52) U.S. Cl. CPC A01D 34/008; A01D 2101/00; A01D 69/025; A01D 69/03

(57) ABSTRACT

An apparatus and system for a remote control that can be added to a riding tractor mower to allow for the tractor mower to be operated, controlled, and steered by an operator using the hand held control at a location distanced from the tractor mower. An apparatus comprising a hand held controller wirelessly connected to a processor mounted to the tractor mower using a customized bracket that can be electrically connected to the tractor mower and a customized electrical circuit and hydraulic system mounted to the tractor mower using customized brackets and operably connected to the tractor mower's existing electrical and hydraulic systems that can be used to control the operation of the tractor mower.

### CROSS REFERENCE TO RELATED APPLICATIONS

The present application claims priority to U.S. Provisional Patent Application No. 63/125,110, filed on Dec. 14, 2020, the disclosure of which is hereby incorporated by reference in its entirety.

### BACKGROUND OF THE INVENTION

### Field of the Invention

The present invention relates to an apparatus, system, and method for a remote control for a mower, for example a Ventrac 4500 tractor, with a front mower attachment and dual wheels, typically used on steep grades, slopes, hills, golf courses, highway medians and sides, and other uneven terrain.

### Background of the Invention

Ventrac ride-on tractors with mower attachments are used to mow grass and brush on steep grades, slopes, hills, golf courses, airports, highway medians and sides, and other uneven terrain. The person riding on and operating and controlling the Ventrac tractor is, thus, subject to the potential danger of the tractor tipping, rolling over, falling down a hill or steep grade, or the operator falling off the tractor.

A remote control device for a Ventrac tractor, and in particular, for example, a Ventrac 4500 tractor with a front mower attachment and dual wheels, is not currently available on the market.

There is, thus, a need for a remote control to operate mowers, such as a Ventrac tractor, without a person riding on the mower on steep grades, slopes, hills, and other uneven terrain.

### SUMMARY OF THE INVENTION

The following description is merely exemplary in nature and is in no way intended to limit the invention, its application, or uses. While the description is designed to permit one of ordinary skill in the art to make and use the invention, and specific examples are provided to that end, they should in no way be considered limiting. It will be apparent to one of ordinary skill in the art that various modifications to the following will fall within the scope of the appended claims. The present invention should not be considered limited to the presently disclosed embodiments, whether provided in the examples or elsewhere herein.

The present invention relates to an apparatus and system, and method of operating the apparatus and system, comprising a remote control for a mower, and in particular, in one embodiment, for example, a Ventrac 4500 tractor, with a front mower attachment and dual wheels.

A remote control for a Ventrac tractor according to one embodiment of the present invention comprises a hand held controller wirelessly connected to a processor mounted on the tractor that can be used to control the operation of the Ventrac tractor from a safe location distanced from, but within a line of sight to, the Ventrac tractor and a customized electrical circuit and hydraulic system mounted in the Ventrac tractor that allows the Ventrac tractor to be operated, controlled, and steered by the operator using the hand held controller at a location distanced from the tractor.

In one embodiment of the invention, a remote control for a Ventrac 4500 ride-on tractor with a front mower attachment comprises a Kar-Tech remote control modified and customized to operate a Ventrac 4500 tractor with a front mower attachment. The remote control comprises a remote hand held unit and a tractor-mounted processor connected via circuitry, hydraulic lines and connections, actuators, and custom brackets for holding the actuators in place, to a valve mounted in the tractor operably connected to the steering and propulsion systems in the tractor.

In other preferred embodiments, a customized remote control unit comprising a hand held controller in remote communication with customized electrical and hydraulic connections and controls on a tractor or mower can be used to control the operation, including the speed, direction, and mowing, of the tractor or mower from a location distanced from the tractor.

### BRIEF DESCRIPTION OF THE DRAWINGS

FIG. 1 is a perspective view of a Ventrac 4500 tractor with a front mower attachment and dual wheels incorporating one embodiment of the invention and operating remotely.

FIG. 2 is a schematic diagram of the hydraulic system for one embodiment of the invention.

FIG. 3 is a perspective view of a custom mounting bracket used to mount the valve actuators in one embodiment of the invention.

FIG. 4 is side perspective view of a Kar-Tech hand held remote control used in one embodiment of the invention.

FIG. 5 is top view of the switches, buttons, and dials on a Kar-Tech hand held remote control unit used in one embodiment of the invention.

FIG. 6 is a perspective view of a hydraulic valve used in one embodiment of the invention.

FIG. 7 is a perspective view of an actuator that is built by Kar-Tech used with one embodiment of the invention.

FIG. 8 is a side perspective view of the Kar-Tech remote control receiver used with one embodiment of the invention.

FIG. 9 is a top view of the Kar-Tech remote control receiver used with one embodiment of the invention.

FIG. 10 is a perspective view of a 12 volt throttle control used with one embodiment of the invention.

FIG. 11 is a schematic circuit diagram for one embodiment of the invention.

FIG. 12 is a side perspective view of a purpose built L-shaped part and a customized bracket for mounting an actuator used to operate the system in one embodiment of the invention.

FIG. 13 is a perspective view of a connection rod operably connect to the existing hydraulic valve control customized brackets as mounted in a tractor in one embodiment of the invention.

FIG. 14 is a perspective view of a steering actuator for steering the tractor mounted to custom brackets attached to the extra steering valve that was added to the existing Ventrac tractor in one embodiment of the invention.

FIG. 15 is a perspective view of the Kar-Tech Can Ranger remote control processor unit fixedly mounted to the tractor using a custom mounting bracket in one embodiment of the invention.

FIG. 16 is a perspective view of a custom made drive actuator arm operably connected to a drive actuator and welded to an existing control function control arm in one embodiment of the invention.

FIG. 17 is a side perspective view of a custom mounting bracket that is used to mount the drive actuator to the tractor in one embodiment of the invention.

### DETAILED DESCRIPTION OF THE PREFERRED EMBODIMENTS

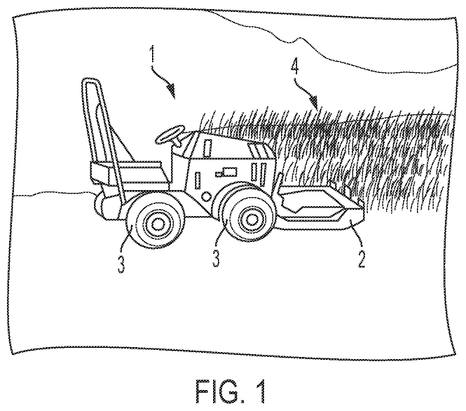

With reference to FIG. 1, in one embodiment, a ride-on Ventrac 4500 tractor 1 with a front mower attachment 2 and dual wheels 3 can be configured to operate via a remote control without an operator riding on the tractor comprising a hand held unit in wireless communication with a tractor mounted processor and modifications to the electrical and hydraulic systems of the tractor to mow grass and brush 4, as depicted in FIG. 1.

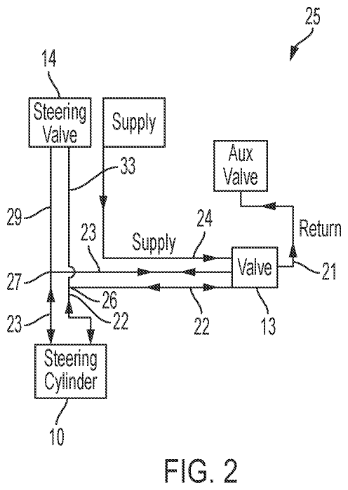

With reference to FIG. 2, in one preferred embodiment, the hydraulic system of the Ventrac tractor 1 can be modified to be operable using a Kar-Tech remote control comprising a hand held remote control unit and a remote control processor mounted on the tractor 1. As shown in FIG. 2, hydraulic lines 21, 22, 23 were added to the Ventrac tractor's existing hydraulic system 25 to make remote control operation possible. T-fittings 26, 27 were used to connect added hydraulic lines 22, 23 to existing hydraulic lines 29, 33 respectively. The added hydraulic lines 21, 22, 23 are operably connected via actuators 31 (not shown in FIG. 2) to an extra steering valve 13 mounted in a custom box mounted on the back of the Ventrac tractor 1. This valve 13 allows the Ventrac tractor 1 to be steered through operation of the steering cylinder 10 either using the original Ventrac steering wheel valve 14 or the extra steering valve 13 for remote operation. The hydraulic supply line 24 to the auxiliary control valve 15 of the Ventrac tractor 1 can be moved to connect first to the extra steering valve 13 for remote control of the steering cylinder 10 and the added return line 21 can be connected between the auxiliary control valve 15 and the extra steering valve 13 to allow for hydraulic supply and control of the auxiliary control valve 15.

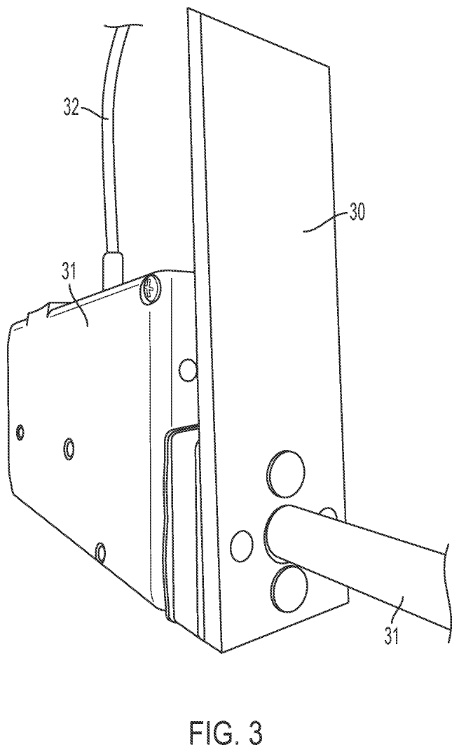

As shown in FIG. 3, in one embodiment, a custom mounting bracket 30 is used to mount the valve actuators 31 to the tractor 1. There are three such mounting brackets 30 and three different valve actuators 31 in one embodiment. The three different valve actuators 31 are a steering valve actuator 311, a drive actuator 312, and a mower up/down actuator 313. The valve actuators 31 are electrically connected via a connection 32 to the tractor mounted control unit controller (not shown) and are moved to open and close the extra steering valve 13 when the remote is used to control the tractor 1.

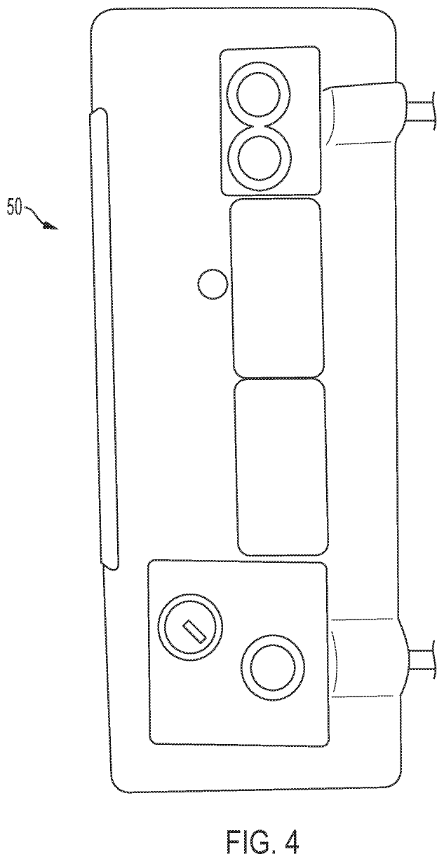

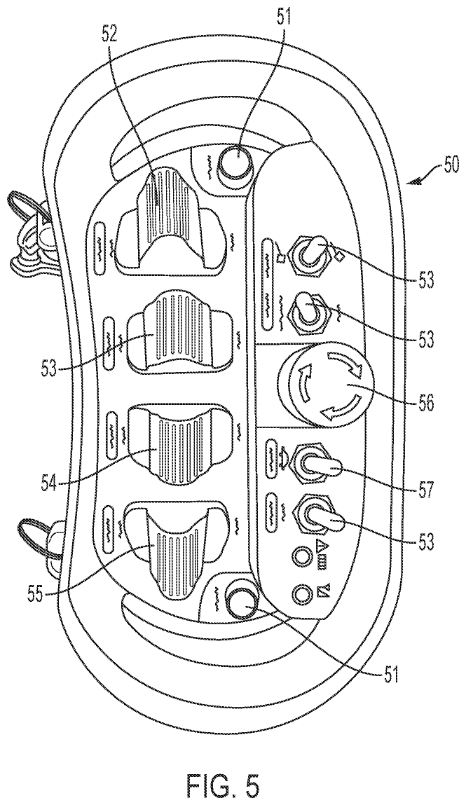

As shown in FIGS. 4 and 5, in one preferred embodiment, the hand held remote control unit 50 is part of a system available from Kar-Tech. This Kar-Tech system is typically used in a crane, rather than a mower or tractor, but was modified in one embodiment to be used with a Ventrac tractor. A remote control purpose built to be used with the Ventrac tractor 1 or other mowers could also be constructed.

FIG. 4 shows a side view of the Kar-Tech remote unit 50. FIG. 5 shows a top view of the Kar-Tech hand held remote control unit 50 comprising a plurality of buttons 51, knob 56, or mechanical switches 52, 53, 54, 55, 57 that can be used in conjunction with the processor 40 to control the operation of the tractor 1. Each one of the plurality of buttons 51, knob 56, switch 57 or mechanical switches 52, 53, 54, 55, 57 on the Kar-Tech hand held remote unit can be configured or programmed to control or activate a different function on the tractor 1 or mower, including without limitation, for example, speed of the tractor 1, activation of the mower attachment 2 or other attachments, steering or direction of the tractor 1, engine on and off for the tractor, and braking of the tractor 1. In one embodiment depicted in FIG. 5, a first mechanical switch 52 can be configured or programmed to activate the forward and reverse function on the tractor 1, a second mechanical switch 54 can be configured or programmed to activate the up or down function of the mower attachment 2, a third mechanical switch 55 can be used to steer the tractor 1 left or right, a first knob 56 can be turned to activate an emergency shutdown, and a fourth mechanical switch 57 can be used to turn the mower attachment 2 on or off. Switches 53 and buttons 51 are not used in the embodiment depicted in FIG. 5, but could be programmed or configured to activate different or additional functions, actuators, controls, or features that could be added to the tractor 1 or the system.

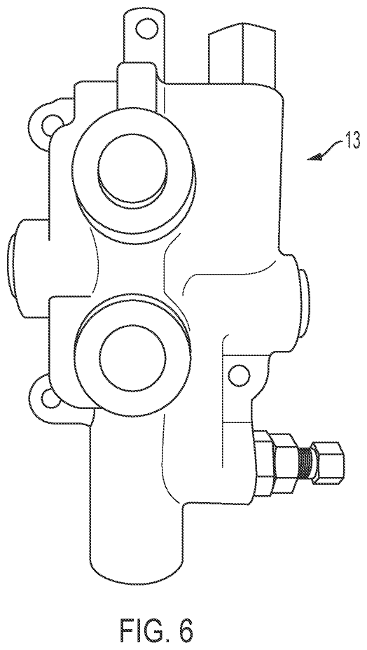

FIG. 6, shows one preferred embodiment of the extra steering valve 13 depicted in FIG. 2 that can be connected to the existing hydraulic system 25 for the tractor 1 to facilitate remote control operation. The extra steering valve 13 can be mounted in a custom box on the back of the tractor 1 and hydraulically connected to a steering cylinder 10 for the tractor 1 via additional 3000 psi lines extending from the valve 13 to T-fittings 26, 27 which are connected to the existing lines 29, 33 and to the added lines 23, 22 in the tractor 1 connected to the steering cylinder 10. As also shown in FIG. 2, the extra steering valve 13 can be connected via a return line 21 to the Ventrac tractor's 1 auxiliary control valve 15. This can be accomplished for a Ventrac tractor 1 by removing the hydraulic supply line 24 from the auxiliary control valve 15 on the Ventrac tractor 1 and moving it to connect with the extra steering valve 13 which can be the type of valve 13 added for remote control operation depicted in FIG. 6. The hydraulic return line 21 can, thus, be connected between the extra steering valve 13 depicted in FIG. 6 and the auxiliary control valve 15 as shown in FIG. 2.

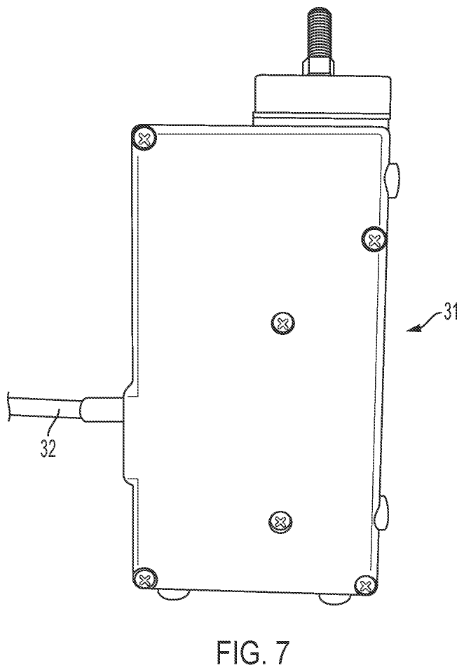

FIG. 7 shows an actuator 31 that is built by Kar-Tech to be electronically connected via a connection 32 with the Kar-Tech remote control processor 80 in one embodiment of the invention. This actuator 31 can be used to move and operate the hydraulic steering valve 13 in the tractor 1 that operates the steering function of the tractor 1.

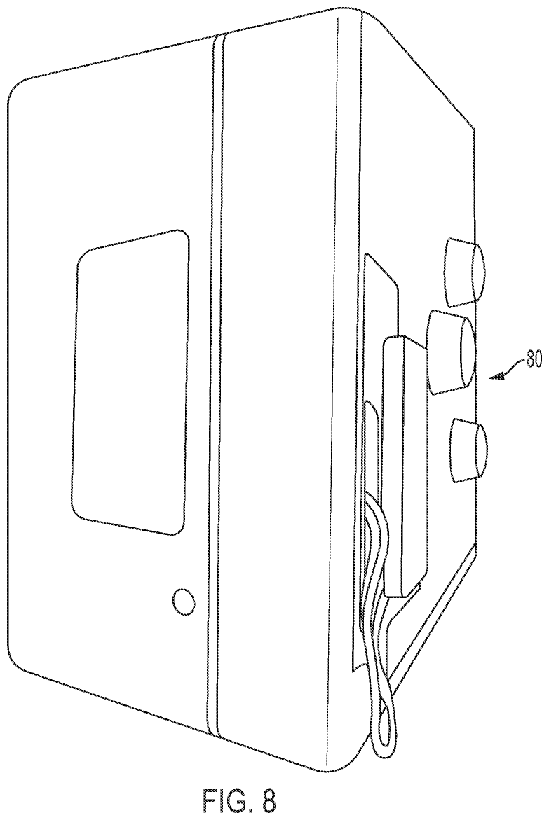

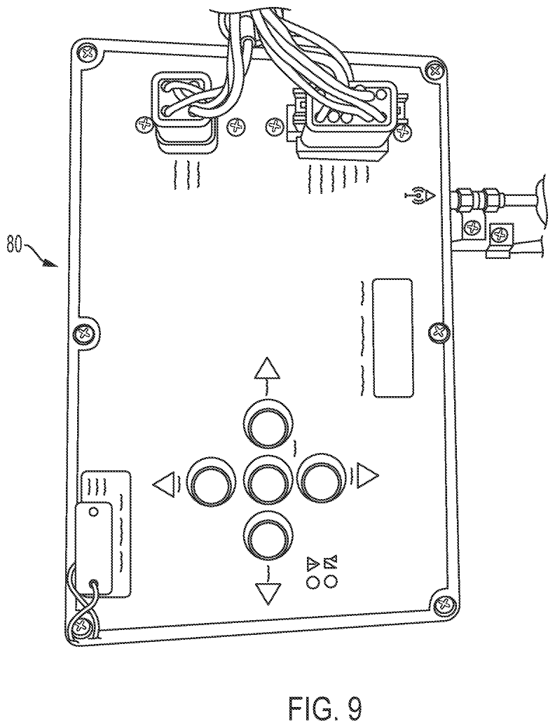

FIGS. 8 and 9 depict two different views of a Kar-Tech Can Ranger remote control processor unit 80 that can be mounted on a tractor 1 or mower that the Kar-Tech hand held remote control unit 50 wirelessly communicates with. The remote control processor unit 80 electrically connects to the actuator 31 as shown in FIG. 7 and controls the extra steering valve 13 shown in FIG. 6 and in FIG. 2. A purpose-built processor or suitably programmed off the shelf processor could be substituted for the Kar-Tech processor 80. In one embodiment, the Kar-Tech Can Ranger remote control processor unit 80 can be a Kar-Tech Versa Remote.

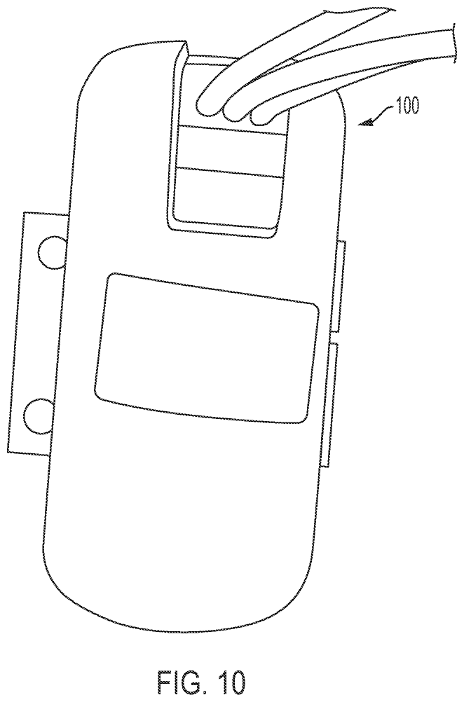

FIG. 10 shows a 12 volt throttle control 100 that can be used in one embodiment to control and move the RPMs of the tractor up and down. Such a throttle control unit 100 can be electrically connected to the remote-control processor unit 80, as shown in FIGS. 8 and 9. In one embodiment, the 12 volt throttle control 100 can be a Rombetta P613-K2V12 unit marked with a U.S. design Pat. No. D342,941.

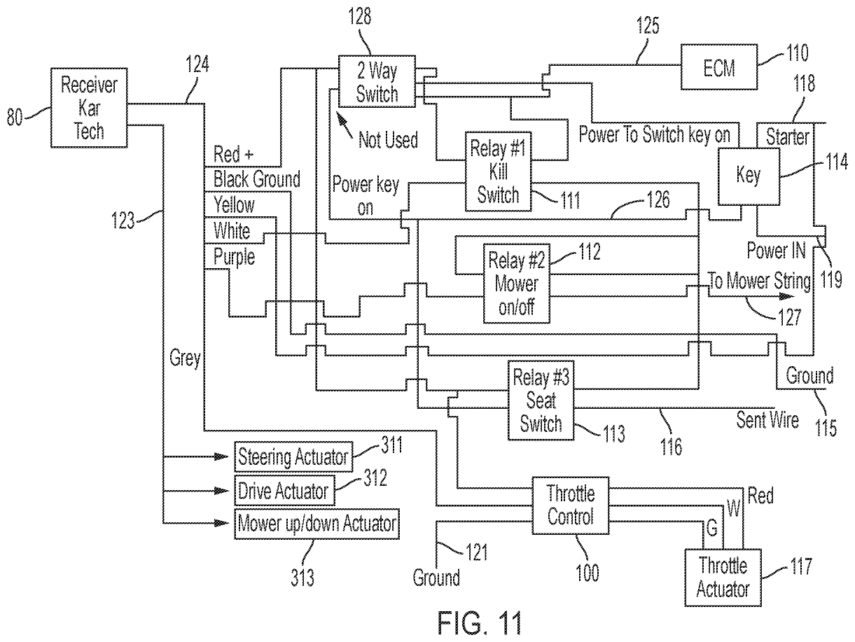

FIG. 11 shows a schematic circuit diagram for one embodiment of the remote control system that can be used with a Ventrac tractor 1 and a Kar-Tech remote control hand held unit 50 and Kar-Tech receiver or remote control processor unit 80 which receives a radio or wireless remote control signal from the Kar-Tech remote control hand held unit 50. Such a circuit can be purpose built as a wiring harness designed to wire the remote control processor unit 80 or receiver to an existing Ventrac tractor 1 to enable remote control of operation of the tractor 1. The circuit comprises an Engine Control Module or ECM 110 that is electrically connected to the circuit via a connection or wire 125 and a plurality of relay units 111, 112, 113 electrically connected to the circuit including a first relay unit for a kill switch 111, a second relay unit for a mower on/off switch 112, and a third relay unit for a seat switch 113. The key 114 for the tractor 1 can be electrically connected to the circuit via a connection or wire 126 and used in conjunction with the starter 118 and the power in 119 electrical connection to power up operation of the electrical circuit for the remote control system. The Kar-Tech receiver or remote control processor unit 80 can be electrically connected via the electrical connection 124, which can be a wire, with the throttle control 100 for the tractor 1 which controls the throttle actuator 117, which can be added to the tractor to enable remote control operation of the tractor's 1 throttle. The Kar-Tech receiver or remote control processor unit 80 can be electrically connected via an electrical connection 125, which can be a plurality of wires, to the steering valve actuator 311, drive valve actuator 312 and mower up/down valve actuator 313, which can be added to the existing Ventrac tractor 1 to enable remote control operation of the steering, drive, and mower up/down functions of the tractor 1. Electrical connections or wires 115, 116, 127 can be used to electrically connect the system to ground, via a wire 115, to a sent wire 116, and to a mower string 127. The remote control system can also include a two-way switch 128 which may or may not be used.

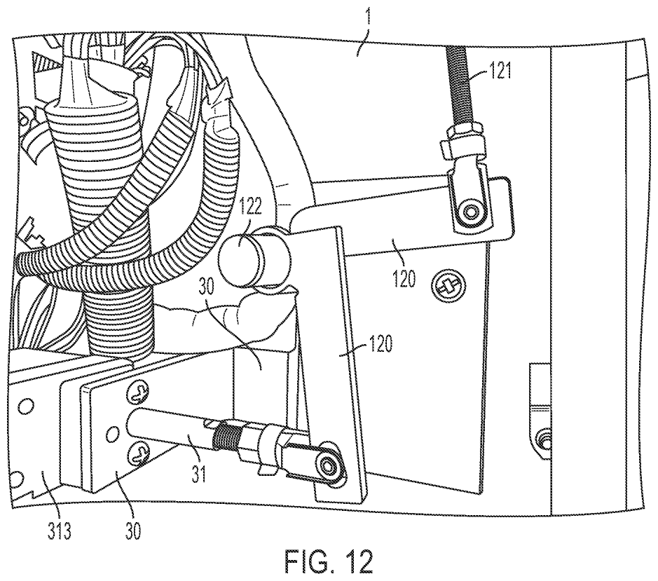

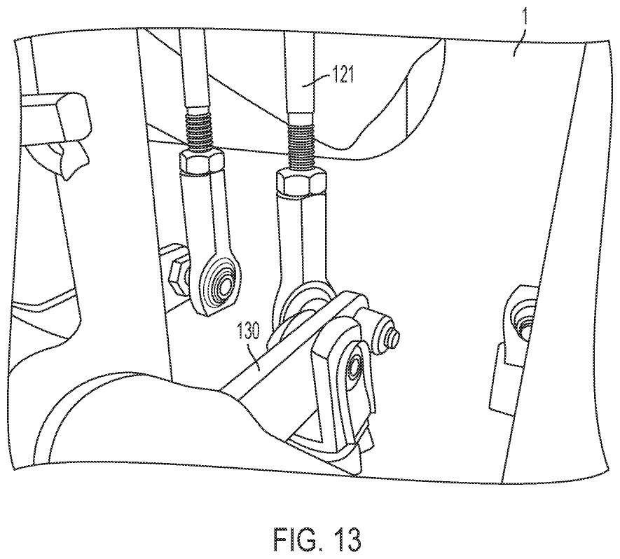

FIGS. 12-17 show custom-made parts or customized brackets used in one embodiment of the invention to connect actuators 31 or the remote control processor unit 80 within or to a tractor 1. FIG. 12 depicts a side view of an L-shaped custom built control arm 120 to assist in the operation of the mower attachment 2 up and down function. The L-shaped custom built control arm 120 is pivotably mounted to the tractor 1 via a metal rod 122 which is fixedly mounted to the tractor 1. The L-shaped purpose built control arm 120 is operably connected on a first end to a mower up/down valve actuator 313 that is mounted in the tractor 1 using a bracket 30 and is operably connected on a second end to a hydraulic valve that operates the mower deck or the mower deck directly (not shown in FIG. 12) via a connection rod 121. FIG. 13 depicts the second end of the connection rod 121 operably connected to the existing hydraulic valve control 130 that operates the up and down function of the mower attachment 2.

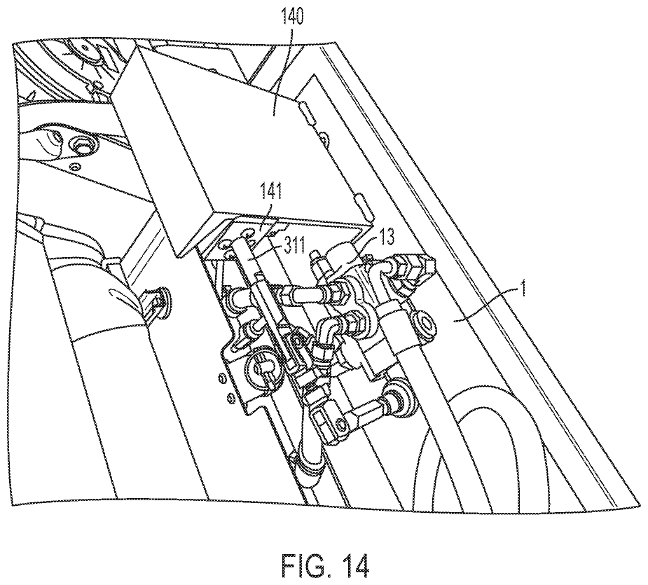

FIG. 14 depicts a steering valve actuator 311 for steering the tractor 1 mounted to custom brackets 140, 141 attached to the extra steering valve 13, also shown in FIG. 6, that was added to the existing Ventrac tractor 1.

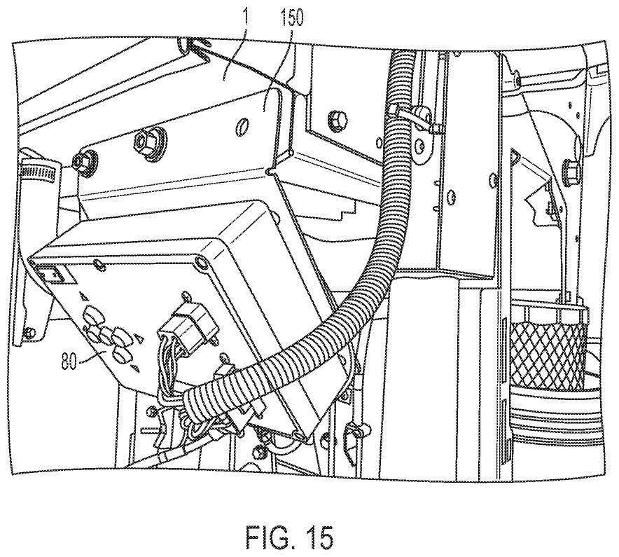

FIG. 15 shows the Kar-Tech Can Ranger remote control processor unit 80, shown in FIG. 8 and FIG. 9, fixedly mounted to the tractor 1 using a custom mounting bracket 150.

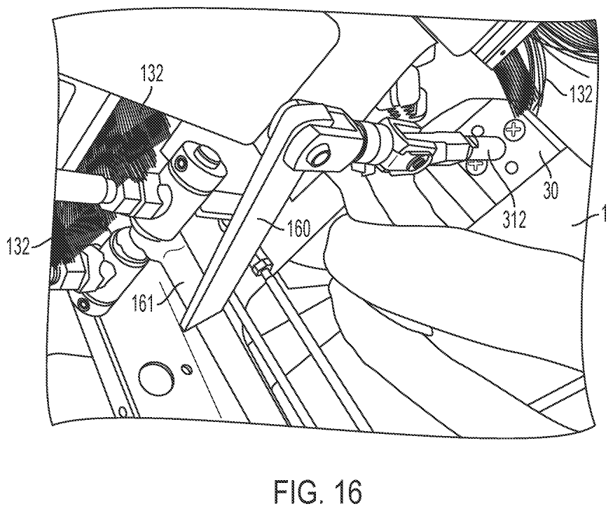

FIG. 16 depicts a custom made drive actuator arm 160 operably connected to a drive valve actuator 312 and welded to an existing control function control arm 161 of a drive mechanism for moving the tractor 1 in a forward and reverse direction. The drive valve actuator 312 is connected to the tractor 1 using a custom bracket 30. Existing brushes 132 mounted in the tractor 1 are not altered by the addition of the actuator 312.

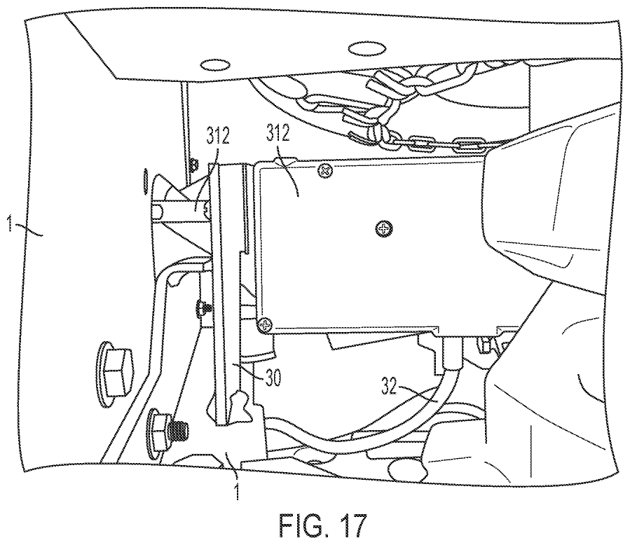

FIG. 17 depicts a side view of the custom mounting bracket 30 that is used to mount the drive actuator 312 to the tractor 1 as it is mounted in the tractor 1. FIG. 3 shows this custom mounting bracket 30 attached to the drive valve actuator 312 before it is mounted to the tractor 1. In FIG. 17 the valve actuator 31 that is depicted is for the forward and reverse function and is electronically connected via the connection 32 to the remote control processor unit 80.

While the present invention has been described in terms of the above examples and detailed description, those of ordinary skill will understand that alterations may be made within the spirit of the invention. It is to be understood that the invention may assume various alternative variations and step sequences, except where expressly specified to the contrary. It is also to be understood that the specific devices and processes illustrated in the attached drawings and described in the specification are simply exemplary embodiments or aspects of the invention. Although the invention has been described in detail for the purpose of illustration based on what is currently considered to be the most practical and preferred embodiments or aspects, it is to be understood that such detail is solely for that purpose and that the invention is not limited to the disclosed embodiments or aspects, but, on the contrary, is intended to cover modifications and equivalent arrangements that are within the spirit and scope thereof. For example, it is to be understood that the present invention contemplates that to the extent possible, one or more features of any embodiment or aspect can be combined with one or more features of any other embodiment or aspect.

The invention claimed is:

1. A remote control system for a Ventrac 4500 tractor comprising a front mower attachment and dual wheels, comprising:
a Kar-Tech remote control unit comprising a hand held unit in wireless communication with a tractor mounted remote control processor;
a valve mounted on said tractor; and
a plurality of actuators mounted on said tractor each using a bracket;
wherein said hand held unit comprises a plurality of buttons programmed to remotely control movement and operation of said tractor;
wherein said tractor mounted remote control processor comprises an electronic control unit mounted on said tractor via a bracket and connected via an electrical circuit to the plurality of actuators mounted to said tractor using the brackets;
wherein at least one of said plurality of actuators is operably connected to a first valve; and
wherein said first valve is hydraulically connected to a steering valve mounted on said tractor and said first valve is connected via a return line to an auxiliary valve mounted on said tractor.

2. The remote control system of claim 1, further comprising a second actuator of said plurality of actuators fixedly attached to said tractor and operably connected to an L-shaped control arm which is also operably connected to the front mower attachment and configured to control an up and down function of the mower attachment.

3. The remote control system of claim 2, further comprising a third actuator of said plurality of actuators fixedly attached to said tractor and operably connected to a drive mechanism of said tractor and configured to control the drive mechanism of said tractor.

4. A remote control for a mower comprising an electrical system and a hydraulic system comprising a plurality of valves, comprising:
a hand held control unit wirelessly connected to a mower mounted control unit;
wherein said mower mounted control unit is mounted on said tractor via a customized bracket and electrically connected to a plurality of actuators mounted to said mower using at least one customized bracket for each of said plurality of actuators,
wherein said plurality of actuators are operably connected to said plurality of valves, and
wherein at least one of said plurality of valves is added to the mower and connected to a preexisting hydraulic system for the mower using at least one additional hydraulic line.

5. The remote control for the mower of claim 4, wherein said mower is a Ventrac riding tractor mower.

6. The remote control for the mower of claim 4, wherein said plurality of actuators comprises:
a first actuator operably connected to a steering valve for the mower;
a second actuator operably connected to a mower up and down mechanism for the mower; and
a third actuator operably connected to a drive mechanism for the mower.

7. A system for remotely controlling a tractor comprising:
a hand held control unit comprising mechanical switches wirelessly connected to a tractor mounted processor mounted to said tractor;
wherein said tractor mounted processor is electronically connected to a plurality of valve actuators mounted in said tractor using customized brackets; and
wherein at least a first valve actuator of said plurality of valve actuators is operably connected to a valve added to said tractor that is hydraulically connected to a steering valve in said tractor.

8. The system for remotely controlling the tractor of claim 7, wherein said tractor is a Ventrac riding tractor mower comprising:
a front-end mower attachment operably connected to a second one of said plurality of valve actuators for controlling an up and down movement of the mower attachment.

9. The system for remotely controlling the tractor of claim 7, further comprising:
a second valve actuator of said plurality of valve actuators operably connected to a drive mechanism for said tractor that controls a direction of the tractor in a forward and reverse direction.

10. The system for remotely controlling the tractor of claim 7, further comprising:
an electrical circuit added to said tractor and electrically connecting said tractor mounted processor to said plurality of valve actuators and to a throttle for said tractor to allow said tractor mounted processor to allow operation of said plurality of valve actuators and said throttle.

11. The system for remotely controlling the tractor of claim 7, wherein said hand held control unit and said tractor mounted processor comprise a Kar-Tech remote control unit.

12. The system for remotely controlling the tractor of claim 7, wherein said plurality of valve actuators comprises:
a second valve actuator of said plurality of valve actuators is operably connected to a mower up and down mechanism for the mower; and
a third valve actuator of said plurality of valve actuators is operably connected to a drive mechanism for the mower.
